(19) United States
(12) Patent Application Publication
(10) Pub. No.: US 2010/0233421 A1
(43) Pub. Date: Sep. 16, 2010

(54) Doubly-Curved Mesh

(75) Inventors: Robert J. Lind, Dorchester, MA (US); Lee Minardi, Lexington, MA (US)

Correspondence Address: PROSKAUER ROSE LLP, ONE INTERNATIONAL PLACE, BOSTON, MA, 02110, US

(73) Assignee: Tufts University, Medford, MA (US)

(21) Appl. No.: 12/598,120

(22) PCT Filed: Apr. 28, 2008
(86) PCT No.: PCT/US08/61744

§ 371 Date: Jun. 2, 2010

Related U.S. Application Data
(60) Provisional application No. 60/914,970, filed on Apr. 30, 2007.

(51) Int. Cl. E04B 1/32; B32B 3/18; B23P 11/00

(52) U.S. Cl. 428/108; 29/428

(57) ABSTRACT

A doubly-curved mesh (110) is fabricated based on a customized design. In one aspect, a plurality of material-strips (112) are provided. A length is determined for at least one segment (223) of at least one material-strip based on a distance between points (214) on al geodesic line associated with the material-strip. The plurality of material-strips are connected to form a plurality of quadrilaterals (118) defined by four edges. At least one edge of at least one quadrilateral is modified based on the determined length for the at least one segment to form the doubly-curved mesh.

### FIELD OF THE INVENTION

The present invention relates generally to methods and apparatuses for fabricating a doubly-curved mesh.

### BACKGROUND

Doubly-curved thin shells are challenging to fabricate because of the curved geometry of the shell. Doubly-curved thin shells are fabricated using bulk processes or in assemblies of curved components. For high volume production, as in bulk manufacturing, material is applied to, or pressed against, a curved form. For low volume production, as in the construction of civil structures, pre-curved structural components are assembled and covered to make a solid, thin-shell structure. However, the automated fabrication of thin shells for low volume production is challenging, if not possible, because of the customized pre-curved structural components that are required for each thin shell.

### SUMMARY

In general, in one aspect, fabrication of a doubly-curved mesh described herein is based on a customized design. In an embodiment, a designed surface is numerically mapped and geometric data is extracted from a design. Material-strips are manually and/or automatically assembled according to the design. In another embodiment, material-strips positions are modified to form a doubly-curved mesh. The doubly-curved mesh can be utilized, for example, as a mesh structure or the doubly-curved mesh can be covered, for example, to form a solid thin shell. In some examples, the doubly-curved, mesh thin surfaces are stacked to increase rigidity and/or overlapped to increase the range of the mesh.

In another aspect, there is a method for fabricating a doubly-curved mesh. The method includes providing a plurality of material-strips. Each material-strip includes a plurality of segments. The method further includes determining a length for at least one segment of at least one material-strip based on a distance between points on a geodesic line associated with the material-strip. The method further includes determining a width for at least one material-strip based on a computed twist and/or a computed bending angle. The method further includes connecting the plurality of material-strips to form a plurality of quadrilaterals. Each quadrilateral is defined by four edges. The method further includes modifying at least one edge of at least one quadrilateral based on the determined length for the at least one segment to form the doubly-curved mesh.

In yet another aspect, there is a method for fabricating a doubly-curved mesh. The method includes creating one or more geodesic lines across triangular tessellation surfaces and creating a geodesic net based on the one or more geodesic lines. The method further includes connecting a plurality of material-strips to form a plurality of quadrilaterals. Each quadrilateral is defined by four edges. The method further includes modifying at least one edge of at least one quadrilateral based on the geodesic net.

In other examples, any of the aspects above can include one or more of the following features. The modifying at least one edge distributes strain energy evenly throughout the doubly-curved mesh. The width for the material-strip can be variable. Alternatively, the width for the material-strip can be constant.

In some examples, a plurality of doubly-curved meshes is connected. The connection of the plurality of doubly-curved meshes includes overlapping, extending, and/or interweaving. Each quadrilateral flexes independently from other quadrilaterals in the plurality of quadrilaterals.

In examples, modifying at least one edge changes interior angles of one or more quadrilaterals in the plurality of quadrilaterals. In some examples, one or more geodesic lines which are associated with the material strips are created across triangular tessellation surfaces.

In some examples, a width for at least one material-strip based is determined on a computed bending strain energy of the geodesic line associated with the material-strip.

In examples, the doubly-curved mesh is covered with a material to form a doubly-curved shell. The material is concrete, plastic, and/or resin. In some examples, the material strips of the doubly-curved mesh are formed of or include wood, paper, metal, plastic, and/or resin.

In some examples, the doubly-cured mesh is a form used for a structure.

In some examples, a concrete shell is fabricated by any of the methods as described herein. A vehicle body-panel is fabricated by any of the methods as described herein. A mold is fabricated by any of the methods as described herein. The mold has three dimensions, two dimensions, or one dimension.

In other examples, a mesh shell is fabricated by any of the methods as described herein. The mesh shell includes a reinforcing mat conformed to a shape of the doubly-curved mesh. An antenna is fabricated by any of the methods as described herein. A medical implant is fabricated by any of the methods as described herein.

Any of the approaches, aspects, and/or examples above can provide one or more of the following advantages. An advantage is that the doubly-curved mesh provides scaled prototypes of the doubly-curved surfaces which allow for direct, fast fabrication. Another advantage is that the direct, fast fabrication of the doubly-curved mesh allows for the repeated testing of curved products and/or structures.

An additional advantage is that the doubly-curved mesh can be customized and fabricated for vehicle body-panels or other objects for low-volume manufacturing processes. For example, the doubly-curved mesh can be fabricated for auto body-panels, aircraft and/or spacecraft panels for fuselages and wings, and/or marine hulls for sail and powerboats.

Another advantage is that the doubly-curved mesh can be utilized for mold making and can form one and two-side molds for pre-scribed variable curvature. An additional advantage is that the doubly-curved mesh can be utilized as curved reinforcing mats to fit into curvilinear molds for composite fabrication.

### BRIEF DESCRIPTION OF THE DRAWINGS

The foregoing and other aspects, features, and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is an exemplary doubly-curved mesh;

FIG. 1B is an exemplary doubly-curved mesh;

FIG. 2A is an exemplary partially fabricated quadrilateral;

FIG. 2B is an exemplary quadrilateral;

FIG. 2C is an exemplary flat mesh of material strips;

FIG. 2D is an exemplary mesh with formed curves;

FIG. 2E is an exemplary doubly-curved mesh;

FIG. 2F is an exemplary doubly-curved mesh;

FIG. 3 depicts an exemplary flowchart of the fabrication of a doubly-curved mesh;

FIG. 4 depicts another exemplary flowchart of the fabrication of another doubly-curved mesh;

FIG. 5A is an exemplary material-strip element;

FIG. 5B is an exemplary material-strip element;

FIG. 6A is an exemplary quadrilateral illustrating the interior angles θᵢ;

FIG. 6B is an exemplary thin shell;

FIG. 7A illustrates a quadrilateral;

FIG. 7B illustrates a quadrilateral;

FIG. 7C illustrates a quadrilateral;

FIG. 8A is an exemplary material sheet with material-strips and formed connection holes;

FIG. 8B is an exemplary material sheet with material-strips and formed connection holes;

FIG. 8C is an exemplary plane illustrating material sheets;

FIG. 9A is an exemplary set of robots assembling a doubly-curved mesh;

FIG. 9B is an exemplary set of robots assembling a doubly-curved mesh;

FIG. 10A is an exemplary doubly-curved mesh;

FIG. 10B is an exemplary doubly-curved mesh;

FIG. 10C is an exemplary set of doubly-curved meshes;

FIG. 11A is an exemplary thin shell that illustrates thin shells interwoven together;

FIG. 11B is an exemplary material sheet with material-strips;

FIG. 12A is an exemplary solid thin shell;

FIG. 12B is an exemplary solid thin shell; and

FIGS. 13-19 are exemplary graphs and equations utilized in the fabrication of a doubly-curved mesh.

### DETAILED DESCRIPTION

### Doubly-Curved Mesh

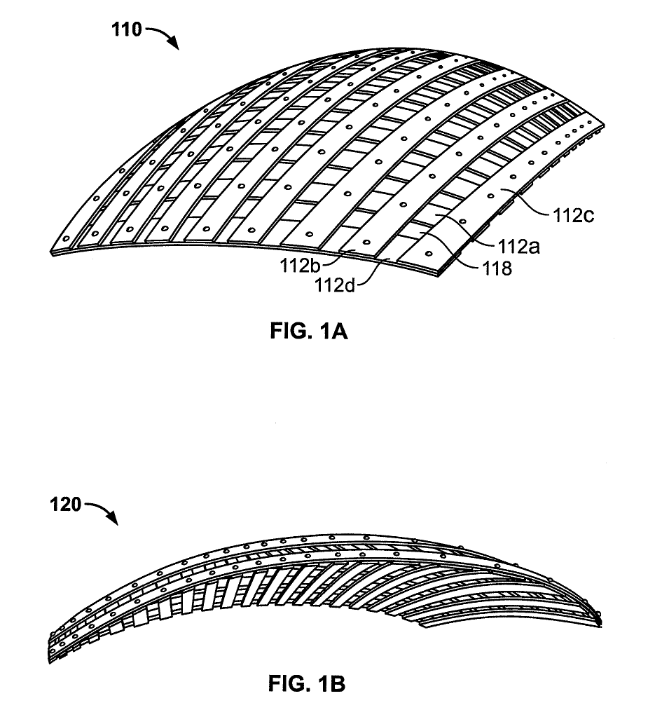

FIGS. 1A and 1B illustrate exemplary doubly-curved meshes 110 and 120. FIGS. 1A and 1B depict the plurality of material-strips connected together to form quadrilaterals as described below. The doubly-curved mesh 110 includes a plurality of material-strips 112a, 112b, 112c, and 112d (generally 112). The plurality of material-strips 112 are formed from any material. For example, the material-strips 112 can be formed from material that is easily manipulated but rigid enough to hold a shape (e.g., paper, polymers, thin metal strips, etc.).

The material-strips 112 are attached to one another to form the mesh 110 according to geometric data extracted from a customized design to form a geodesic dome. Specifically, the material-strips 112 are positioned and attached to form a plurality of quadrilaterals 118. Each quadrilateral 118 has customized lengths of each of its four segments (as described below) which form a portion of the geodesic dome and are determined from the geometric data from the geodesic dome. As a result, the plurality of material-strips 112 are positioned and connected so that each quadrilateral 118 has customized dimensions (as described below) as extracted from the geometric data.

The embodiment of the doubly-curved mesh 110 shown in FIG. 1A has twenty material-strips 112, in which nine of the twenty material-strips 112a are positioned in a somewhat horizontal fashion and eleven of the twenty material-strips 112b are positioned in a somewhat vertical fashion. The material-strips 112a and 112b are connected together to form eighty quadrilaterals 118 as shown in FIG. 1A.

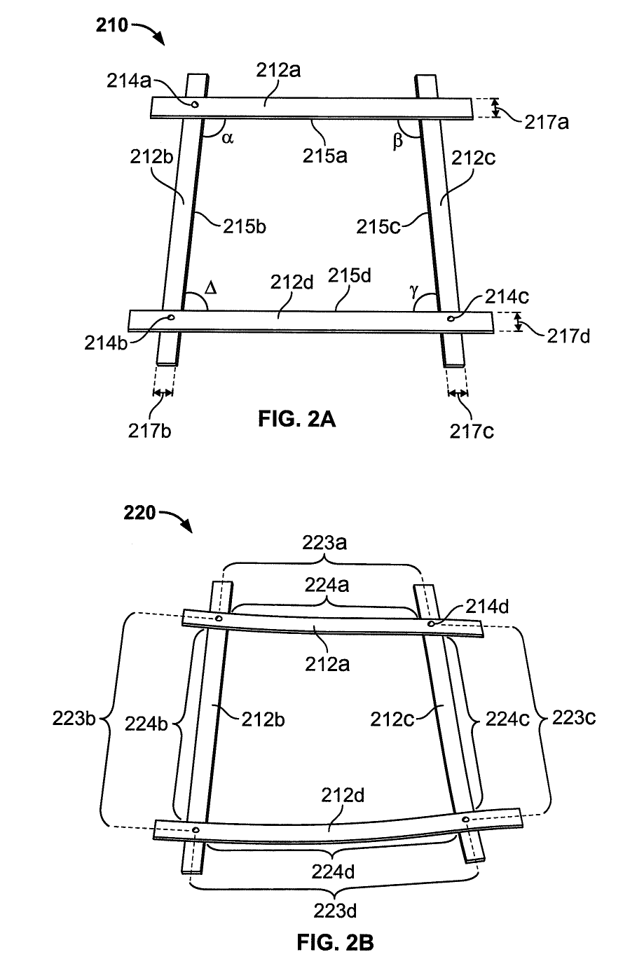

FIG. 2A is an exemplary partially fabricated quadrilateral 210 having four right angles α, β, γ, and Δ that sum to 2π radians. The partially fabricated quadrilateral 210 when completed illustrates one of the plurality of quadrilaterals 118 in the doubly-curved mesh 110 of FIG. 1A. As partially fabricated, the quadrilateral 210 is flat and includes four material-strips 212a, 212b, 212c, and 212d (generally 212), which are loosely attached by three connectors 214a, 214b, and 214c. In this example, the material strips 212 define four equal length edges 215a, 215b, 215c, and 215d (generally 215). In this example, the four material-strips 212a, 212b, 212c, and 212d of FIG. 2A correspond to portions of the material-strips 112a, 112b, 112c, and 112d of FIG. 1A, respectively.

FIG. 2B is an exemplary quadrilateral 220 illustrating the quadrilateral 210 of FIG. 2A after fabrication. That is, quadrilateral 220 is formed after partially fabricated quadrilateral 210 is completed. The quadrilateral 220 includes segments 223a, 223b, 223c, and 223c (generally 223) and edges 224a, 224b, 224c, and 224d (generally 224). In this exemplary quadrilateral 220, the angles of the quadrilateral 220 are not right angles and the total interior angles α, β, γ, and Δ sum to greater than 2π radians so the quadrilateral 220 is curved. That is, to complete fabrication of quadrilateral 210 of FIG. 2A to form quadrilateral 220 of FIG. 2B, the length the edges 215a and 215c of quadrilateral 210 are modified by repositioning the material strips 212a and 215c from their original positions shown in FIG. 2A to their modified positions shown in FIG. 2B. The quadrilateral 220 illustrates one of the eighty quadrilateral 118 in the doubly-curved mesh 110 of FIG. 1A that is described above in FIG. 2A after the modification of the edges 224.

Specifically, each quadrilateral 118, 220 of the doubly-curved mesh 110 can be thought of as being formed from a plurality of segments 223. (See FIGS. 1A and 2B.) These segments 223 each have a length which is defined by the length between the connections 214a, 214b, 214c, and 214d (generally 214). Each edge 224 of the quadrilateral 118, 220 also has a length which is defined by the length between the corners of the quadrilaterals or the length of the respective segment 223 minus the width 217 of the respective material-strips 212 (in this example, the width 217 is halved since the connection is in the center of the material-strip 212). To form quadrilateral 220 from partially fabricated quadrilateral 210, one or more of edges 215 is modified (i.e., length is changed) by positioning and connecting strips 212 so that the length of each edge 224, and as a result its respective segment length, correspond to the geometric data. In some embodiments, the length of each edge 224 and the respective segment length is part of the customized dimensions of the quadrilateral 210, 220. For example, the edge 224c is modified based on the determined length of segment 223c and the widths 217a and 217d of the material-strips 212a and 212d, respectively.

The edges 224 of the quadrilateral 220 are thus uniquely defined. That is each edge 224 is modified from forming a right angle as illustrated in quadrilateral 210 based on the determined length for each segment 223. The modification of the edges 224 of the quadrilateral 220 forms the doubly-curved mesh 110. For example, the top and right edges 224a and 224c, respectively, are shortened by sliding the material-strips 212a and 212c over one another and connecting the strips together at the intersection 214d. The lengths of the top and right edges 224a and 224d, respectively, are modified based on a determined length for the edges 224a and 224d which is determined based on the length of the segments 223a and 223d and the widths of the material-strips 217a and 217d.

Referring back to FIG. 2A, the lengths of the segments 223 of the material-strips 212a, 212b, and 212d are determined based on points on a geodesic line associated with each material-strip 212. The geodesic line being a piece of geometric data extracted from the customized design of the geodesic dome. The edges 215 are modified based on the determined lengths of the segments 223. In the partially fabricated quadrilateral 210, the edges 215b and 215d for two of the segments 224b and 224d associated with material-strips 212b and 212d are positioned to form right angles α and Δ between the material-strips 212b and 212d based on the determined lengths of the respective segments 223b and 223d. The material-strips 212a and 212b, 212b and 212d, and 212d and 212c are connected together at connections 214a, 214b, and 214c, respectively. In some examples, the connections 214 are temporarily made between the material-strips 212, the edges are modified, and then the connections 214 are permanently made between the material-strips 212.

Each material-strip 212a, 212b, 212c, and 212d has a width 217a, 217b, 217c, and 217d (generally 217), respectively. The width 217 of each material-strip is determined based on a computed twist and/or a computed bending angle of the material-strip. Although FIG. 2A illustrates the material-strips 212 having the same width 217, each material-strip 212 can have a different width 217 and/or a variable width 217.

The doubly-curved mesh 110 can be fabricated, for example, by providing a plurality of material-strips 112 of FIGS. 1A, 2A, and 2B (in this example, twenty material-strips). The doubly-curved mesh 110 is fabricated by determining a length for a segment 223 of a material-strip 112. The segment length is determined based on a distance between points on a geodesic line associated with the material-strip 112 (e.g. length between the connections of the material-strips 112). The width 217 is determined for the material-strip 112. The width 217 is determined based on a computed twist and/or a computed bending angle extracted from the design of the geodesic dome. The plurality of material-strips 112 are connected 214 to form the plurality of quadrilaterals 118. Each quadrilateral 118 is defined by four edges 224. At least one edge 224 of the quadrilateral 118 is modified based on the determined length for the segment 223. The modification of the edge 224 of the quadrilateral 118 forms the doubly-curved mesh 110.

As another example, the doubly-curved mesh 110 is fabricated by creating one or more geodesic lines across triangular tessellation surfaces. A geodesic net is created based on the one or more geodesic lines. The plurality of material-strips 112 are connected to form the plurality of quadrilaterals 118. Each quadrilateral 118 is defined by four edges 224. At least one edge 224 of the quadrilateral 118 is modified based on the geodesic net.

In some examples, the computed twist is the twisting of the material-strip 112 that is caused by the connecting of the material-strips 112 and the modification of the edges 224. The computed bending angle can be the angle of each segment 223 of the material-strip 112 after the edge 224 is modified based on the determined length of the segment 223. The computed twist and/or the computed bending angle can be automatically calculated based on the designed strain energies that apply to the material-strip 112.

In other examples, the modification of the lengths of the edges 224 of the material-strips 112 distribute the strain energy evenly throughout the doubly-curved mesh 110. For example, if the stain energy is concentrated in the top right hand side of the doubly-curved mesh 110, the length of one or more edges 224 is modified to distribute the strain energy through the doubly-curved mesh 110. Each quadrilateral 118 in the plurality of quadrilaterals can advantageously flex independently from the other quadrilaterals. The independent flexing can enable the distribution of strain energy through the doubly-curved mesh 110.

In some examples, the doubly-curved mesh 110 is manually fabricated using pre-drilled holes in the material-strips 112. For example, the manual fabrication includes aligning and connecting the holes. The aligning and connecting the holes includes arranging the individual material-strips 112 into a Cartesian grid on a flat surface. The axes are fastened together and each material-strip 112 is fastened to an axis. Beginning at a set starting location (e.g., origin of the axes), quadrilaterals 118 are sequentially formed by sliding material-strips 112 over each other to align the holes and the connections.

In other examples, the doubly-curved mesh 110 is automatically fabricated using a computer-controlled machine to repeatedly align the holes and make the connections. For example, individual material-strips 112 are assembled with a computer-controlled assembly machine configured as a loom. The material-strips 112 can be, for example, automatically fed from the opposing directions and positioned to make the connections. An overhead robotic Cartesian arm can be utilized, for example, to assemble material-strips 112.

In some examples, the material-strips 112 are connected and/or modified by using predetermined lengths (e.g., two centimeters, ⅛ of an inch), dynamically determined lengths (e.g., based on the geodesic line associated with the material-strip 112, based on the geodesic net, etc.) and/or a predetermined angle (e.g., 0.25 degrees, 1 degree) between the segments 223 and/or edges 224. The assembly of the material-strips 112 forms a mesh with intrinsic surface properties (e.g., slope, pitch, etc.).

In other examples, the predetermined and/or dynamical determined lengths and/or the predetermined and/or dynamical determined angles of the segments 223 and/or the edges 224 are set to a precise distance utilizing automated computer controlled machine (e.g., robotics). The doubly-curved meshes 110 can be designed by computer aided design software implementations. An advantage is that the mesh 110 can be fabricated directly from a computer design which reduces variability, improves output quality, and provides consumers with more selections at a lower cost.

In some examples, the doubly-curved mesh 110 is used as assembled with no covering. The doubly-curved mesh 110 can be covered forming a solid thin shell. The doubly-curved mesh 110 can be covered with concrete, resin, plastic, styrofoam, and/or any other type of covering. A reinforcing mat can be utilizing in the mesh shell for reinforcement. The reinforcing mat can be shaped to the doubly-curved mesh 110.

In other examples, the doubly-curved mesh 110 is used as a design prototype and/or as a final part. An advantage is that multiple design prototypes can be repeatedly tested because of the direct and fast fabrication of the meshes 110. Another advantage is that the direct and fast fabrication allows for various curvatures of designed products or structures to be tested before final construction of the product or structure.

In some examples, the doubly-curved mesh 110 is a vehicle body, a mold, and/or any other type of product. The vehicle body can be, for example, an aircraft fuselage, an auto body-panel (e.g., custom build car, antique car), and/or a boat hull. Other types of products include, for example, an antenna dish, curved structures with reflectors and/or receivers (e.g., symmetric or asymmetric dishes to receive radar, radio, and TV signals, solar collectors), a skull implant, plastic or collagen curved meshes, and/or a sculptured design accessory. The mold can be one-dimensional, two-dimensional, or three-dimensional. An advantage is that the mesh 110 is easily assembled in the field and can be used by remote communities, by the military, and/or in space (e.g., solar sail, mirror). The mesh 110 can be utilized for body reconstruction and/or tissue remodeling.

In other examples, the doubly-curved mesh 110 is a curvilinear reinforcement that fits inside composite molds and/or a curvilinear composite mold. The doubly-curved mesh 110 can be utilized, for example, as a curvilinear formwork for placing cast concrete for foundations and/or walls. The mesh 110 can be assembled, for example, edge to edge, onto a frame, and/or made into a single large piece. In other examples, the mesh is made of metal, resin, plastic, and/or an advanced material such as carbon-fiber and/or Kevlar.

In some examples, the mesh 110 is utilized for civil structures with variable curvatures. The civil structures include small and intermediate sized architectural structures with smooth and undulating organic shapes. The civil structures include roofs, walls, swimming pools, and/or any other type of variable curvature structure.

In some examples, the material-strips 112 are manually assembled into small and/or medium sized curvilinear structures (e.g., buildings). The material-strips 112 can be covered, for example, with concrete and/or other types of structural material. An advantage is that the speed of building variable-curved structures would increase and the cost of building variable-curved structures would decrease which would increase the construction of variable-curved structures.

FIG. 2C is an exemplary flat mesh 230 (i.e., a mesh prior to fabrication of a doubly-curved mesh) of material-strips 232a and 232b (generally 232) that are connected together. The flat mesh 230 is utilized as a base form for fabrication into the doubly-curved mesh 240 of FIG. 2D. The material-strips 232 are loosely connected together to form the plurality of quadrilaterals 238a, 238b, and 238c (generally 238). Each quadrilateral 238 includes four segments (as described above) and four edges (as described above). In this example of a flat mesh 230, each quadrilateral 238 has four right angles α, β, γ, and Δ that sum to 2π radians.

FIG. 2D is an exemplary mesh 240 with several formed curves (i.e., a flat mesh that has been fabricated into a curved mesh). The doubly-curved mesh 240 is fabricated from the base form of the flat mesh 230 of FIG. 2C. The mesh 240 includes the plurality of material-strips 232 that are permanently and/or securely connected together as described herein to include a plurality of quadrilaterals 248a, 248b, and 248c (generally 248). As an illustration, in one of the quadrilaterals 248c, the length of the edge 244 is modified from its base flat position (as illustrated in quadrilateral 238c of FIG. 2C) to its modified position with a new length which is secured with permanent connectors 245. The edge 244 and other edges of other quadrilaterals are modified based on determined lengths of the segments (as described above) calculated from the geometric data to form the curved mesh 240.

For example, the material-strips 232 of FIG. 2C are positioned to form the flat mesh 230 and temporarily connected together (e.g., bolts are not tightened, pegs are inserted, etc.). The flat mesh 230 is utilized as the base form for the fabrication of the doubly-curved mesh 240 of FIG. 2D. The edges 244 of the quadrilaterals 248 are modified (e.g., portions of the material strips are repositioned or adjusted) based on the geometric data and the connections 245 are permanently and/or securely connected together (e.g., bolts are tightened, rivets are placed, etc.). That is, the doubly-curved mesh 240 is fabricated from the base form of the quadrilaterals as illustrated in the flat mesh 230.

FIG. 2E is an exemplary doubly-curved mesh 250. The mesh 250 illustrates a doubly-curved mesh that is formed by connecting the plurality of material-strips 252a and 252b (generally 252) and modifying the lengths of the edges 254 of the quadrilaterals 258 to form the doubly-curved mesh 250. The shape of the doubly-curved mesh 250 can be changed by modifying one or more lengths of the edges 254 of the quadrilaterals 258. These lengths can be determined based on the determined length of the segments (illustrated by segments 223 of FIG. 2B). The length of the segments are determined based on a geodesic line of a model of the doubly-curved mesh 250 and/or by other modeling or mathematical mechanisms. Although FIG. 2E is an exemplary doubly-curved mesh 250 with gaps between the material strips, additional material strips could be added to make a smoother and more continuous structure with no or small gaps between the material strips.

FIG. 2F is an exemplary doubly-curved mesh 260 including a material-strip 262, a connection (node) 264, and a quadrilateral 268. The material-strips 262 form the surface of the doubly-curved mesh 260. The material-strips 262 are constrained at the connection 264. In each segment between the connections 264, the material-strips 262 are structural elements in space following paths of minimum strain energy.

### Fabrication

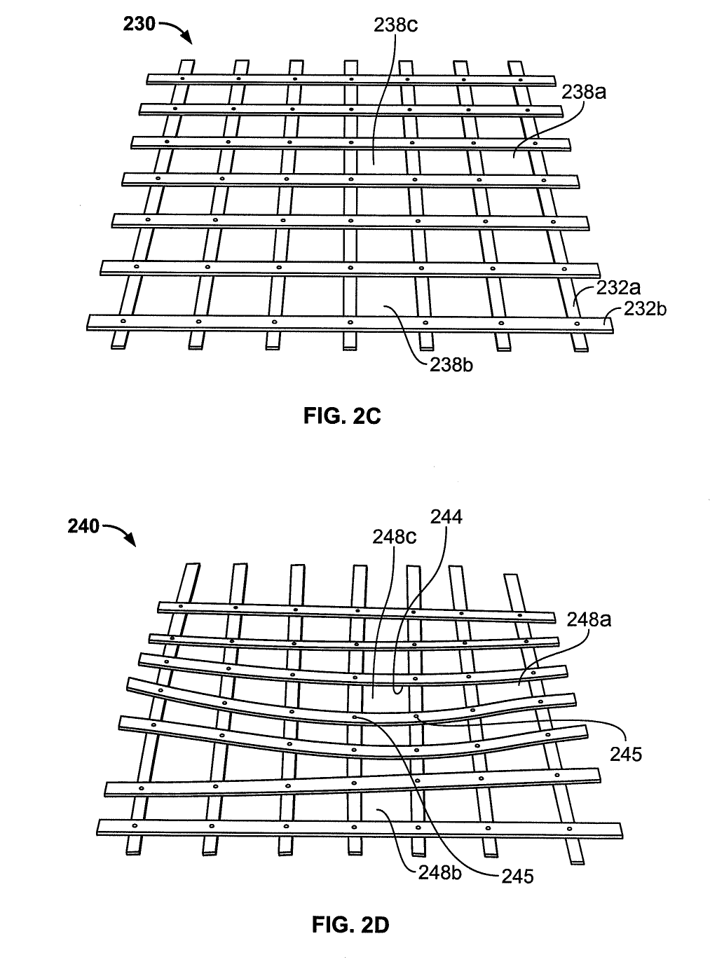

FIG. 3 depicts an exemplary flowchart 300 of the fabrication of a doubly-curved mesh 110 of FIG. 1A, (The fabrication of one of the plurality of quadrilaterals of mesh 110 is shown in FIGS. 2A and 2B.) The fabrication 300 includes providing a plurality of material-strips 112 with segments 223 (310). A length for a segment 223 is determined (320) based on a distance between points on a geodesic line associated with the material-strip 112. The width of a material-strip 217 is determined (330) based on a computed twist and/or a computed bending angle. The material-strips 112 are connected (340) together to form a plurality of quadrilaterals 118 (in FIG. 1A, eighty quadrilaterals). Each quadrilateral 118 includes four edges 224 that are defined by the segments 223 of the material-strips. At least one edge 224 of a quadrilateral 118 is modified (350) based on the determined length of a corresponding segment to form the doubly-curved mesh 110. In some embodiments, a device is created (360) utilizing the doubly-curved mesh 110. For example, the device is a concrete shell, a vehicle body-panel, a mold, a mesh shell, an antenna, a medical implant, a form, and/or any other type of device.

For example in an exemplary fabrication, twenty material-strips 112 are provided (310). Each material-strip 112 includes segments 223. A length of segment 223 is determined (320) based on a distance between points on a geodesic line associated with the material-strip 112. The geodesic line is calculated by a computer aided design (“CAD”) program to simulate the doubly-curved mesh 110 that is being fabricated. The determination (320) of the length of the segment 223 (e.g., one inch, five centimeters, etc.) is based on the geodesic line that corresponds to the material-strip 112 in the CAD design for the doubly-curved mesh 110. The width 217 of the material-strip 112 is determined (330) based on a computed twist and/or a computed bending angle of the material-strip 112. The width 217 can be adjusted to reduce and/or stabilize the computed twist and/or computed bending angle to maximize the useful life of the doubly-curved mesh 110. The material-strips 112 are loosely connected (340) together at connections 214. The length of the edge 224 is modified (350) based on the determined length of the corresponding segment 223. The modification of the edge 224 causes the material-strips 112 to change shape and/or form to become the doubly-curved mesh 110. After the modification of the edge 224, the material-strips 112 can be permanently connected together at the connections 214.

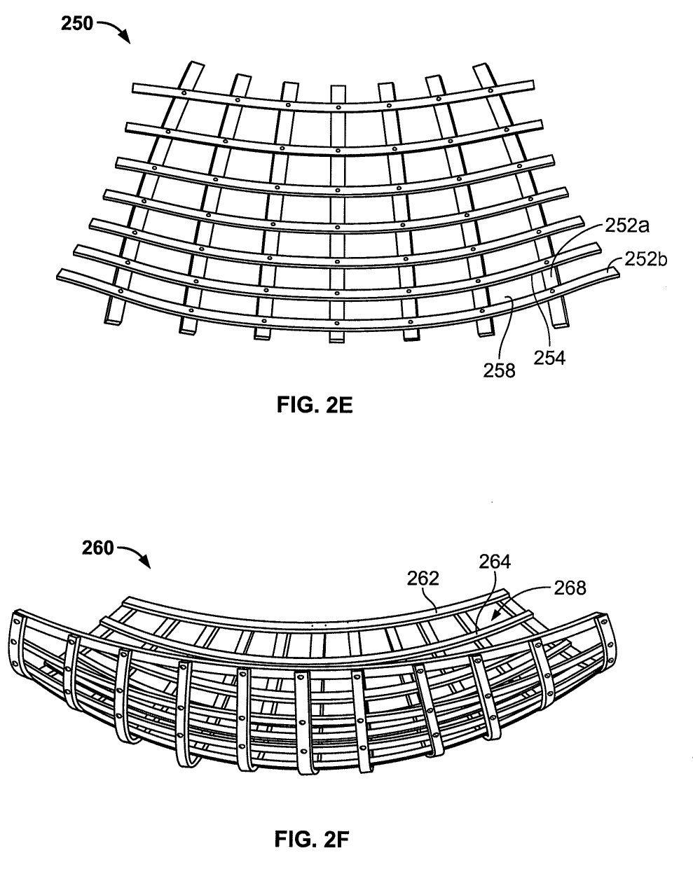

FIG. 4 depicts another exemplary flowchart 400 of the fabrication of another doubly-curved mesh 260 of FIG. 2F. Geodesic lines are created (410) across triangular tessellation surfaces that represent the doubly-curved mesh in a CAD design. A geodesic net is created (420) based on the geodesic lines. The material-strips 262 are connected (430) together to form a plurality of quadrilaterals 268 (in FIG. 2F, eighty quadrilaterals). Each quadrilateral 268 is defined by four edges. An edge of a quadrilateral 268 is modified (440) based on the geodesic net to form the doubly-curved mesh. The second quadrilateral is defined by edges and segment lengths that correspond to the extracted data from the geodesic dome. In some examples, a base form of the mesh 230 of FIG. 2C is temporarily assembled. This base form of the mesh 230 is utilized for the modification (440) of the edge 244 of the quadrilateral 268 to form the doubly-curved mesh 240 of FIG. 2D.

In another example, a CAD design is created to represent a doubly-curved automobile body-panel. Geodesic lines are created (410) across the triangular tessellation surfaces that make up the automobile auto panels in the CAD design. The geodesic lines are utilized to create (420) a geodesic net that represents the doubly-curved automobile body-panel. The material-strips are connected (430) together by a robotic arm to form a eighty quadrilaterals 268. The robotic arm modifies (440) the length the edges of part or all of the eighty quadrilaterals 268 to form the doubly-curved automobile body-panel that represents the CAD design of the automobile body-panel.

### Modeling

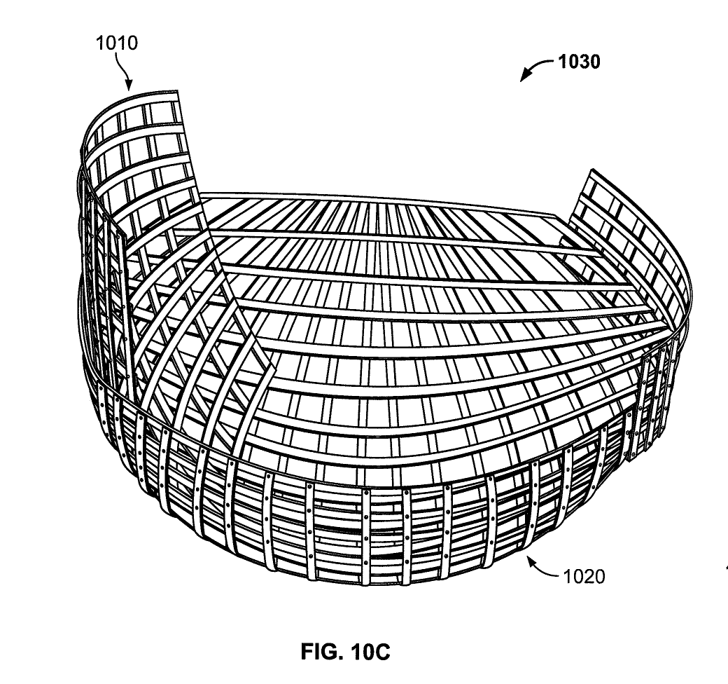

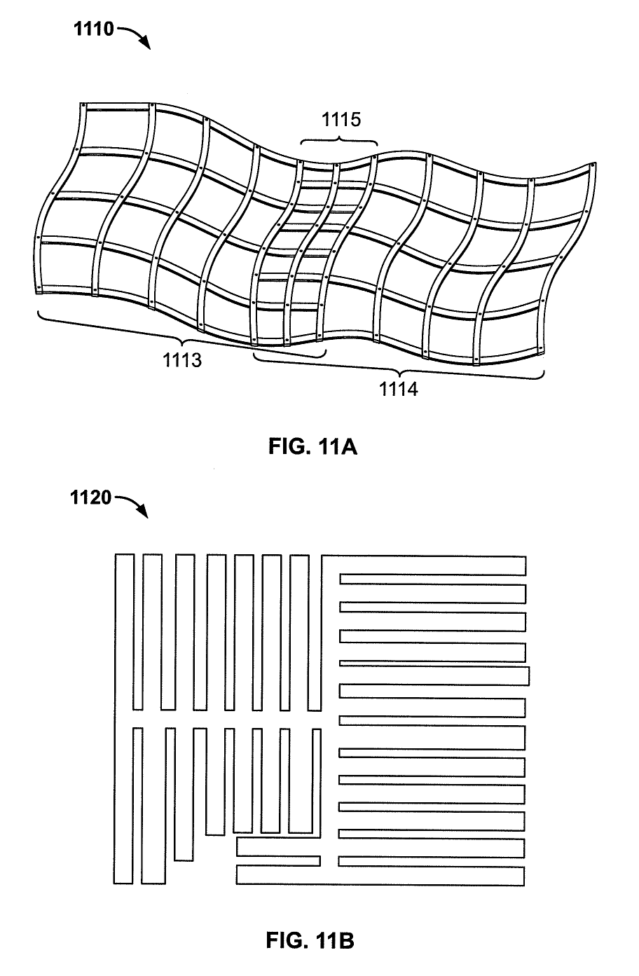

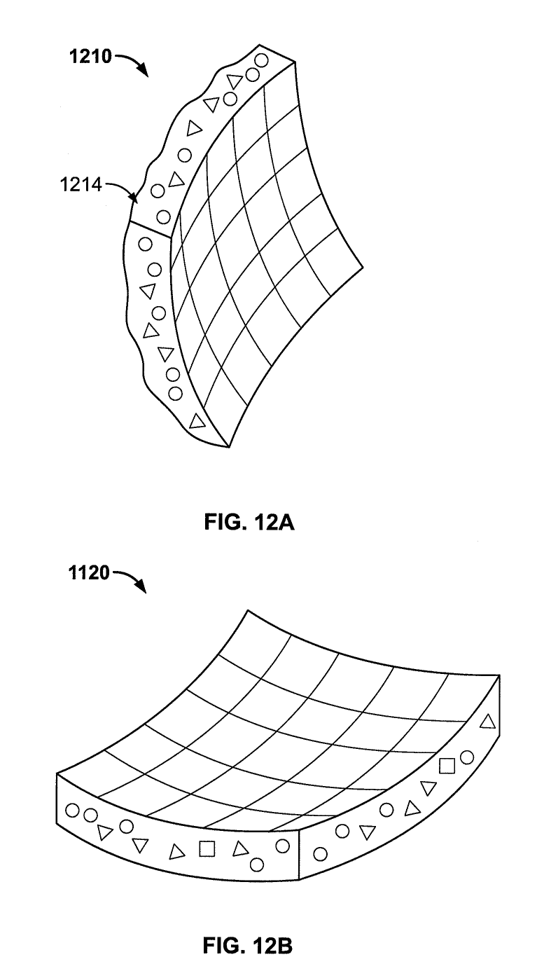

Modeling of different aspects of the doubly-curved mesh 110 is described below utilizing FIGS. 1A, 2A, and 2B. Twist angle Ψ₁ is related to torque T₁, bending angle Ψ₂ is related to moment M₂, and bending angle Ψ₃ is related to moment M₃ as illustrated in FIGS. 13-15.

In some examples, the shape of a path, which is the path of the geodesic line that corresponds to the material-strip 112, in each segment 223 is associated with the cross-sectional geometry of the material-strips 112, the material-strip 112 material stiffness E, and/or the length between the connections l. In other examples, the number of connected material-strips 112 is increased so that the deflections are minimized. The deflections can be minimized, for example, through the utilization of one or more dimensionless parameters (e.g., wide material-strip).

In other examples, the material-strips 112 are variable or constant (e.g., narrow, wide). An advantage is that wide material-strips 112 reduce or eliminate the elements from bending sideways. For example, a natural cross-section is a rectangle with a dimensionless aspect ratio A=w/t.

In some examples, sideways bending is negligible relative to normal bending

$${k}_{g} = \frac{1}{{A}^{2}} {k}_{n}$$

for equivalent applied bending moments, M₂ and M₃. For example, when w=15t, A=15,

$${k}_{g} = \frac{1}{255} {k}_{n} .$$

In other examples, the material-strip 112 is under-constrained such that the twist angle Ψ₁ and the bending angle Ψ₂ in each segment (e.g., 223) trade off with one-another to find the path of minimum strain energy. The deflections can be managed with sufficient numbers of material-strips 112 and/or crossing connections 214.

The normal density Δₙ=1/Ψ₂ (normal bending angle Ψ₂ of a segment) can quantify, for example, the constrainment of a material-strip 112 to its intended path relative to normal curvature kₙ. The tangential density Δₜ=w/l (width w and length l of a segment) can quantify, for example, the spacing of material-strips 112 on the mesh 110. In some examples, when the twist and normal bending deflections are excessive, length l is decreased and/or width w is increased, proportionally.

In some examples, the dimensionless parameter values, Aspect ratio: A>15, Normal density: Δₙ>10, and Tangential density: Δₜ>0.5 are utilized.

In other examples, a material-strip 112 thickness t is sized to prevent yielding. To prevent yielding form twisting, a thickness criteria can be, for example,

$$t < \frac{( 1 + μ ) {σ}_{max}}{τ E} .$$

To prevent yielding from bending, the thickness criteria can be, for example,

$$t < \frac{2 {σ}_{yp}}{Ek} .$$

Stress limits can be set, for example, as a percentage of the maximum yielding stresses from twisting and/or bending. A material-strip's width can be computed, for example, with the value of the thickness, w=Ar·t.

In some examples, the fabrication of the doubly-curved mesh 110 imparts Gaussian curvature which is stored as internal strain energy of the material-strips 112. The internal strain energy Wₜ (also referred to as work input) for each material-strip 112 is illustrated in Equation 1 and the twist of the material-strip 112 is illustrated in Equation 2.

$$\begin{matrix}{W}_{T} = {U}_{T} = {U}_{τ} + {U}_{b} = \frac{l}{2 {EI}_{2}} ( 1 + μ ) {T}_{1}^{2} + \frac{l}{2 {EI}_{2}} {M}_{2}^{2} \\ where \text{:} \\ {T}_{l} = \frac{EI {Ψ}_{1}}{( 1 + μ ) l} ; {M}_{2} = \frac{EI {Ψ}_{2}}{l} \\ {W}_{T} = ( \frac{EI}{2 l} [ \frac{1}{( 1 + υ )} {Ψ}_{1}^{2} + {Ψ}_{2}^{2} ] ) & Equation 1 \\ {Ψ}_{1} = \frac{{BT}_{1} l}{{Gwt}^{3}} = \frac{2 B ( 1 + μ ) {T}_{1} l}{{Ewt}^{3}} & Equation 2\end{matrix}$$

In other examples, the strain energy for a material-strip 112 is calculated is the sum of the torsional strain energy and the bending strain energy of the material-strip 112. The torsional strain energy is associated with the computed twist of the material-strip 112, and the bending strain energy is associated with the computed bending angle of the material-strip 112. The torsional strain energy and/or the bending strain energy can be utilizing to determine a width of a material-strip 112, to determine the length of a segment of a material-strip 112, and/or to modify an edge of a quadrilateral 110.

### Parts and Examples

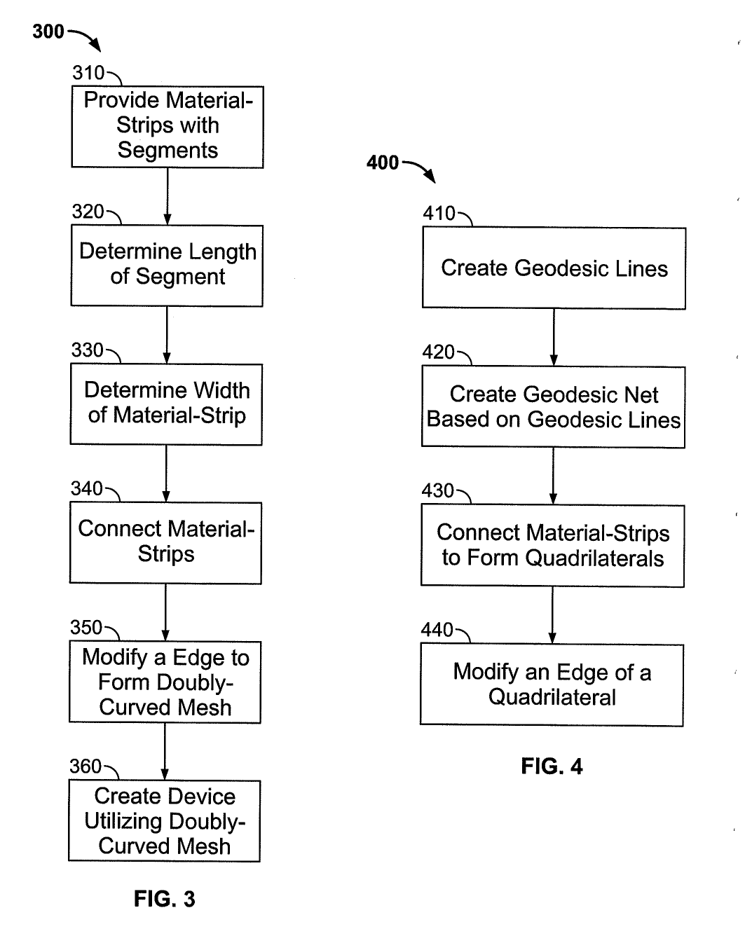

FIG. 5A is an exemplary material-strip 510 that is made by bundling round structural elements 512a and 512b (e.g., metal, wood, plastic, paper). FIG. 5B is an exemplary material-strip element 520 that is made by bundling round structural elements together and covering them with a material 522 (e.g., concrete, resin, styrofoam, plastic). In some examples, the material-strip element is an “off-the-shelf” material. An automated cutter (e.g., water jet, laser) can cut, for example, material-strip elements and form connection holes from sheet material (e.g., metal sheets).

For example, curvature is induced to each quadrilateral 268 (as shown in FIG. 2F) as they are assembled. When three connections 264 are fixed, curvature is induced by sliding the two unconnected material-strip elements across each other. As the sum of the quadrilateral's interior angles change, the Gaussian curvature K changes, and the material-strips 262 twist and curve (“curvature mechanism”). As illustrated in exemplary Equation 1, doubly curvature is quantified as Gaussian curvature K, a point wise surface property. The Gauss-Bonnet Theorem related Gaussian curvature K, surface area A, interior angles θᵢ, and the geodesic curvature of the boundary lines as an elemental area is reduced to zero.

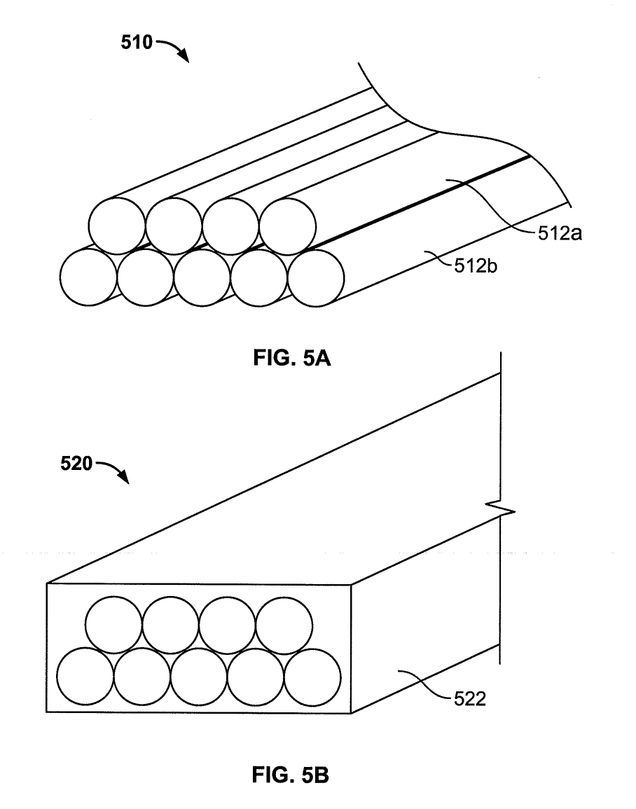

FIG. 6A is an exemplary flat or base form quadrilateral 610 illustrating the interior angles θₐ, θ_{b}, θ_{c}, and θ_{d}. The quadrilateral 610 includes four material-strip 611a, 611b, 611c, and 611d (generally 611). Each material-strip is connected a, b, c, and d at the intersections of the material-strips 611. The length of each edge of the quadrilateral 610 is illustrated by /bc, /ab, /dc, and /da. The width of material-strip 611b is illustrated by 612, and the width of material-strip 611a is illustrated by 614.

FIG. 6B is an exemplary mesh 620 illustrating the curvature mechanism applied to create a doubly-curved mesh from a flat mesh. The work of assembly 622 (e.g., lengths, angles) causes the curvature inducement.

$$\int \int K d A = {\sum }_{i = 1}^{4} {θ}_{i} - 2 π - \int {k}_{g} \qquad Equation 3$$

As illustrated in exemplary Equations 3 and 4, the Gaussian curvature K of a quadrilateral with finite area can be computed. Angular excess Φ is the sum of the interior angles, less 2π.

$$K = \frac{φ}{A} - \frac{\int {k}_{g}}{A} \qquad Equation 4$$

For example, when the material-strips 611 are straight, the elements have zero geodesic curvature k_{g}, and the Gaussian curvature reduces to the quotient of angular excess and area. When the flat quadrilateral 610 is modified to form a doubly-curved quadrilateral, the work of assembly changes its interior angles and induces curvature. The distances on the material-strips 611 can be, for example, precisely set to achieve a surface's specified curvature.

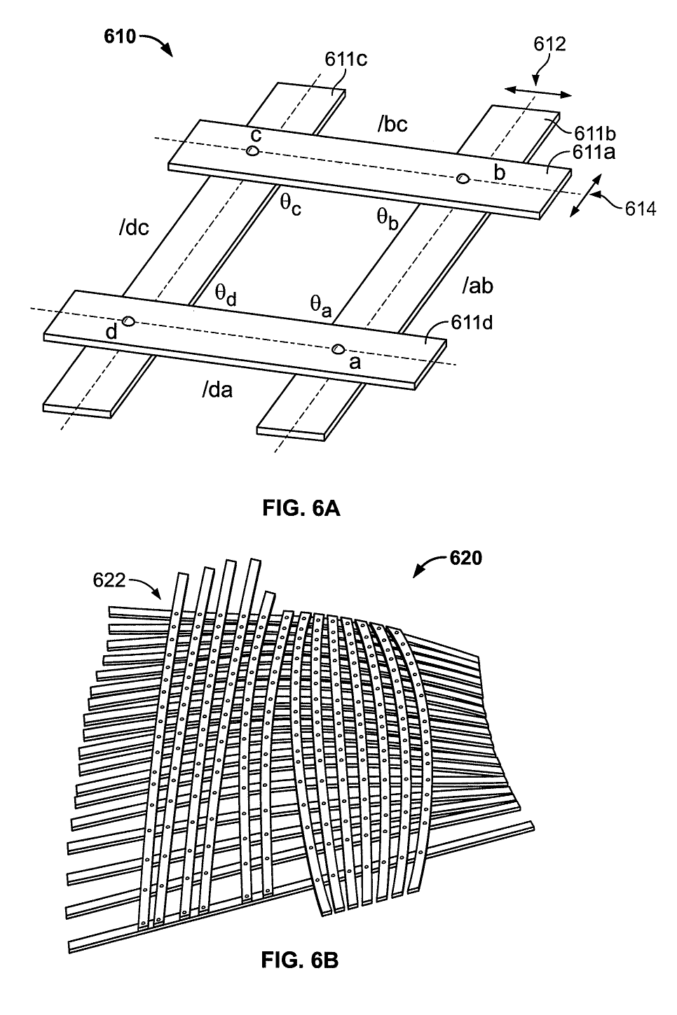

FIG. 7A illustrates a quadrilateral 710 where the interior angles sum to less than 2π and the Gaussian curvature K is negative. The corresponding shape of the quadrilateral 710 is saddle-shaped.

FIG. 7B illustrates a quadrilateral 720 where the interior angles sum to exactly 2π and the Gaussian curvature K is zero. The corresponding shape of the quadrilateral 720 is flat.

FIG. 7C illustrates a quadrilateral 730 where the interior angles sum to more than 2π and the Gaussian curvature K is positive. The corresponding shape of the quadrilateral 710 is cupped. Although FIGS. 7A through 7C each illustrate one quadrilateral, a mesh with a plurality of quadrilaterals can have a corresponding shape that is saddle-shaped, flat, or cupped.

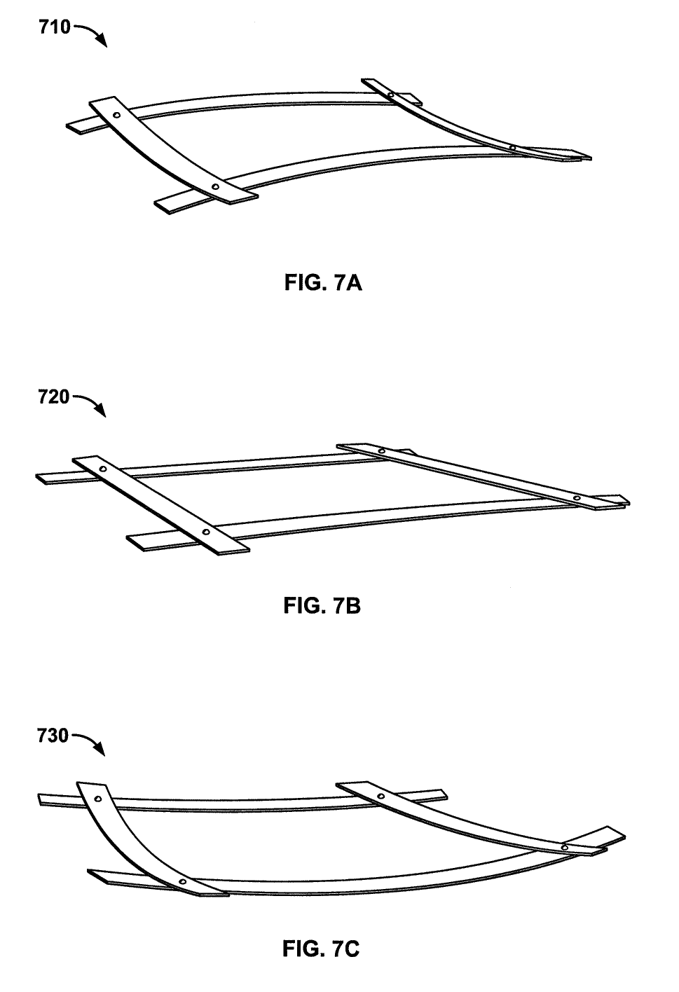

FIG. 8A is an exemplary material sheet 810 with material-strips 814 and formed connection holes 812. FIG. 8B is another exemplary material sheet 820 with material-strips 824 and formed connection holes 822. FIG. 8C is an exemplary plane 830 illustrating the material sheets 810 and 820. The material sheets 810 and 820 can be connected, for example, to form a doubly-curved mesh. The connection holes 812 and 822 on the material sheets 810 and 820 can be cut, for example, according to a predetermined pattern and/or outline.

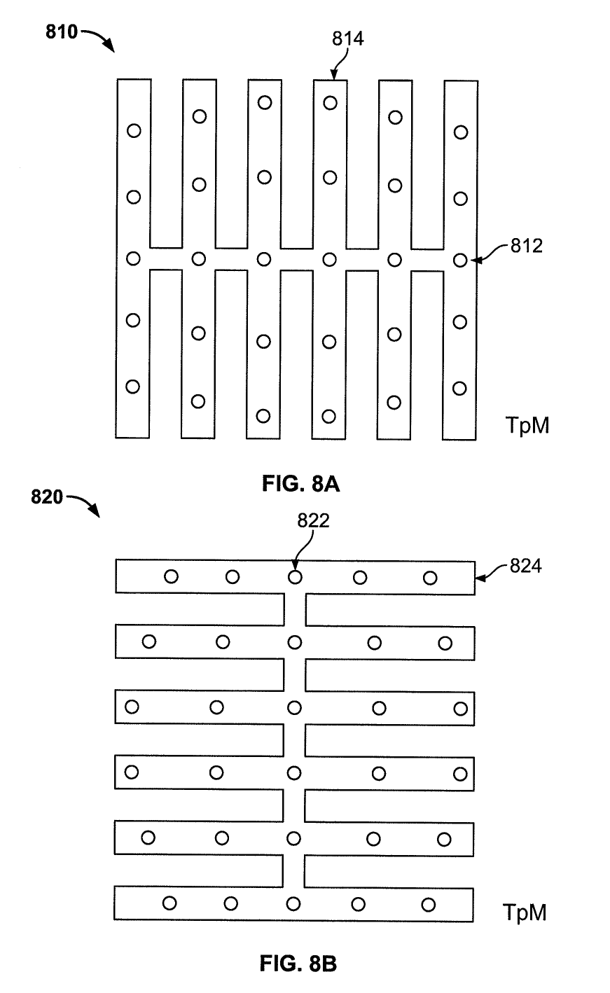

FIG. 9A is an exemplary set of robots 912a and 912b (generally 912) that are assembling a doubly-curved mesh 910. The set of robots 912, one above 912a and one below 912b the material-strips 914, locate the holes, move the predetermined holes together, and make the connection between the set of holes. FIG. 9B is another exemplary set of robots 922a and 922b that are assembling a doubly-curved mesh 924 by connecting the material-strips 914 to form the customized quadrilaterals (i.e., quadrilaterals that are defined by edges and segments that have lengths that correspond to the geometric data extracted from the customized design).

The curvature can be maintained, for example, by the connections between the holes in the material-strip 924. The connections can be made, for example, from a wide variety of methods. The connections can be made, for example, using a screw, a bolt, a snap, and/or any other type of physical connection device. The connections can be made, for example, by welding, brazing, chemical adhering, and/or any other type of connection mechanism. An advantage is that the connection can be changed according to the speed and ease needed for making the connection, the strength of the needed connection, the material-strip material, and/or the shape of the connection heads. Another advantage is that since the work of assembly increases with the number of material-strips 924, the connections can be optimized to the size of the assembly.

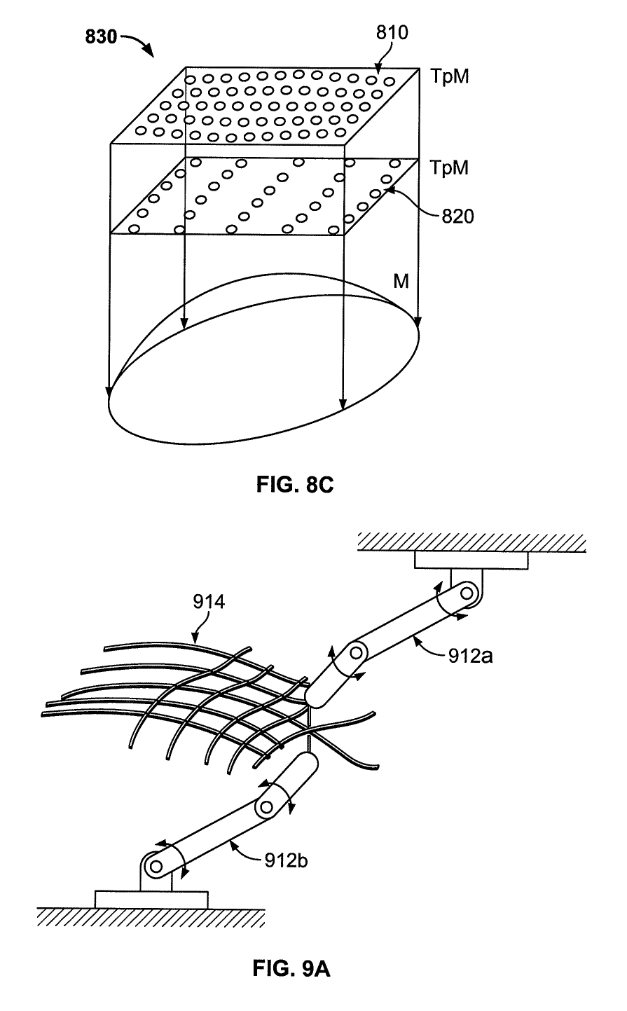

FIG. 10A is an exemplary doubly-curved mesh 1010. FIG. 10B is another exemplary doubly-curved mesh 1020. FIG. 10C is an exemplary doubly-curved mesh 1030 that is stacked with shell 1010 of FIG. 10A and shell 1020 of FIG. 10B. As meshes 1010 and 1020 are stacked together, the stiffness is increased. Each shell can differ in its design and/or density and can be placed together at various orientations to form a strong, dense, curved shell.

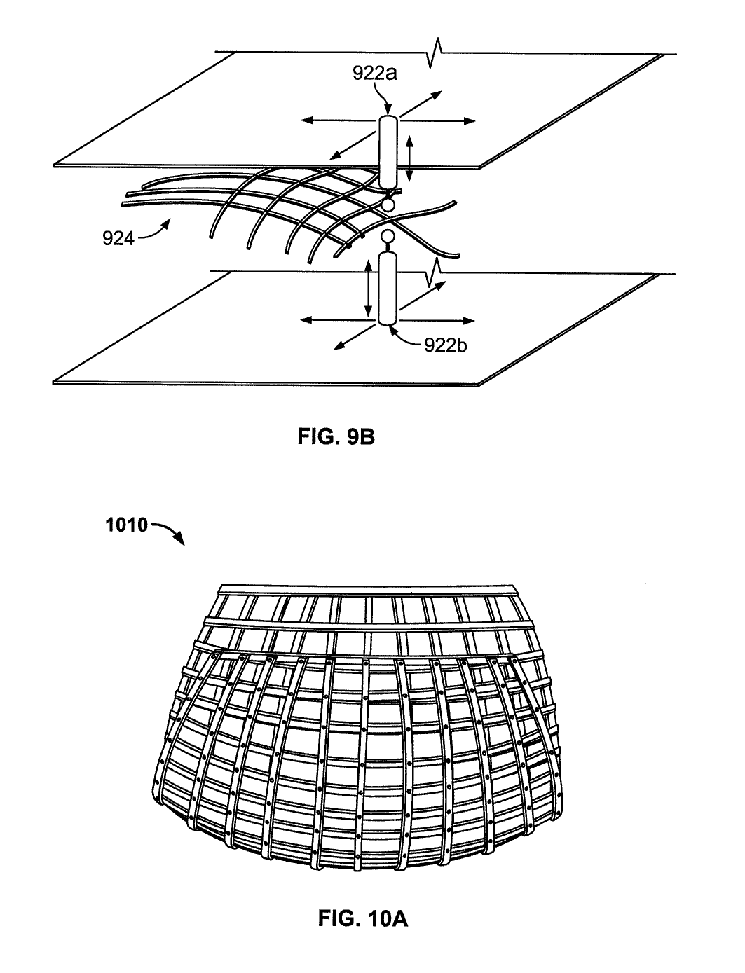

FIG. 11A is an exemplary mesh 1110 that includes two meshes 1113 and 1114 interwoven together. The meshes 113 and 1114 are interwoven together along a section 1115 of each mesh 1113 and 1114. FIG. 11B is an exemplary material sheet like that in FIGS. 8A and 8B. When connection holes are formed in the strips of this material sheet, and the sheet connected to another material sheet, a doubly-curved sheet 1120 can be formed. The material strip lengths, their proximity to other strips, and the number of axis strips, can be non-uniform and non-symmetrical.

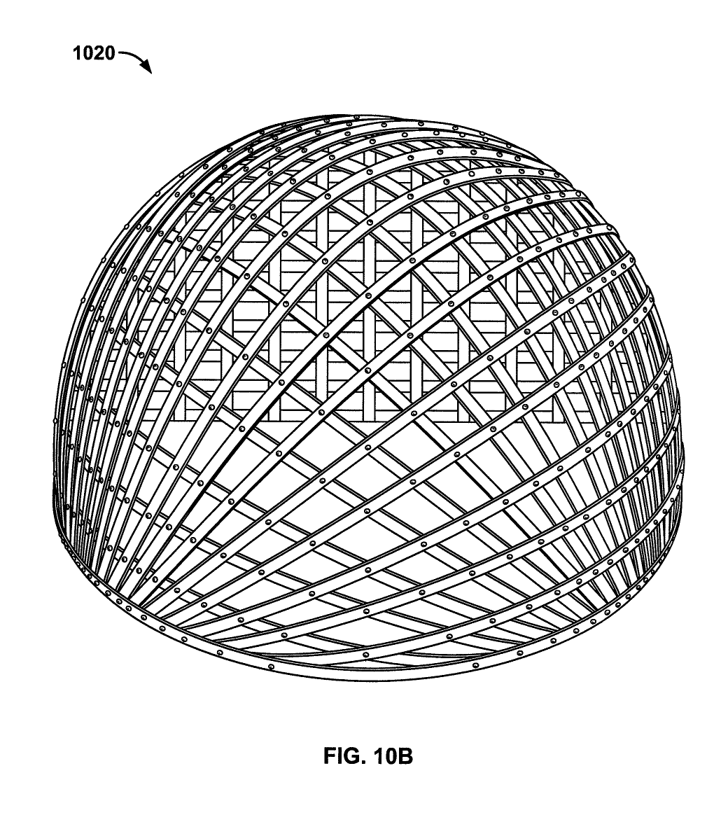

FIG. 12A is an exemplary covered mesh 1210. FIG. 12B is another exemplary covered mesh 1220. Meshes can be covered, for example, with a material 1214 that solidifies into a hard and smooth shell. The covering material can be, for example, applied to single and/or multi-layered meshes. The meshes can be, for example, overlapped and/or extended. A mesh can be dipped repeatedly, for example, into liquid material that solidifies and/or material can be applied directly or sprayed. In other examples, a mesh is utilized as a backing to make a single-sided rigid mold. In some examples, a mesh is used to make a composite sandwich.

### Geodesic Net

A geodesic net on a surface can be created for fabricating a doubly-curved mesh 110 of FIG. 1A. The geodesic net is created based on geodesic lines and is a parameter coordinate system that utilizes the data to indicate when material-strips 112 with arcs are utilized. In other words, the geodesic net is utilized to indicate the bending and/or twisting of the material-strips 112. The geodesic lines are created based on triangular tessellation surfaces on the doubly-curved surface. The triangular tessellation surfaces form an approximation of a curved surface for designs of doubly-curved meshes 110. A geodesic line is extended across a triangular tessellation surface by connecting the edges of the surfaces to form the geodesic lines.

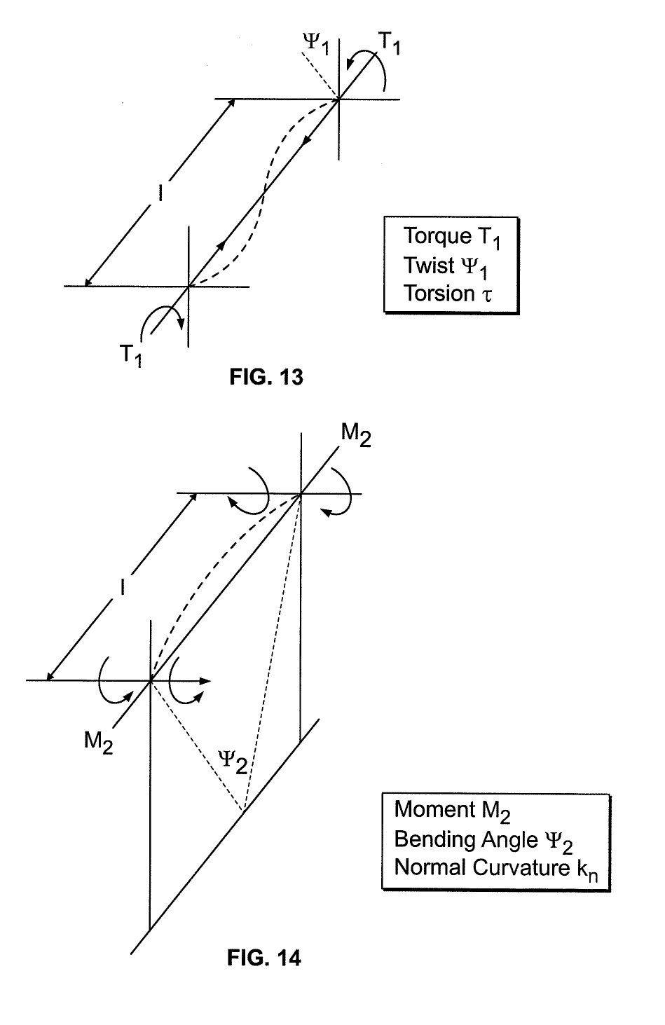

FIG. 16 illustrates the extension of a geodesic line across a triangulated tessellations by the overlay of a surface stripe across a series of tessellations. The Darboux frame vector fᵢ attached to the surface strip crossing a facet's edge will suddenly rotate as it crosses over an edge forming a crease.

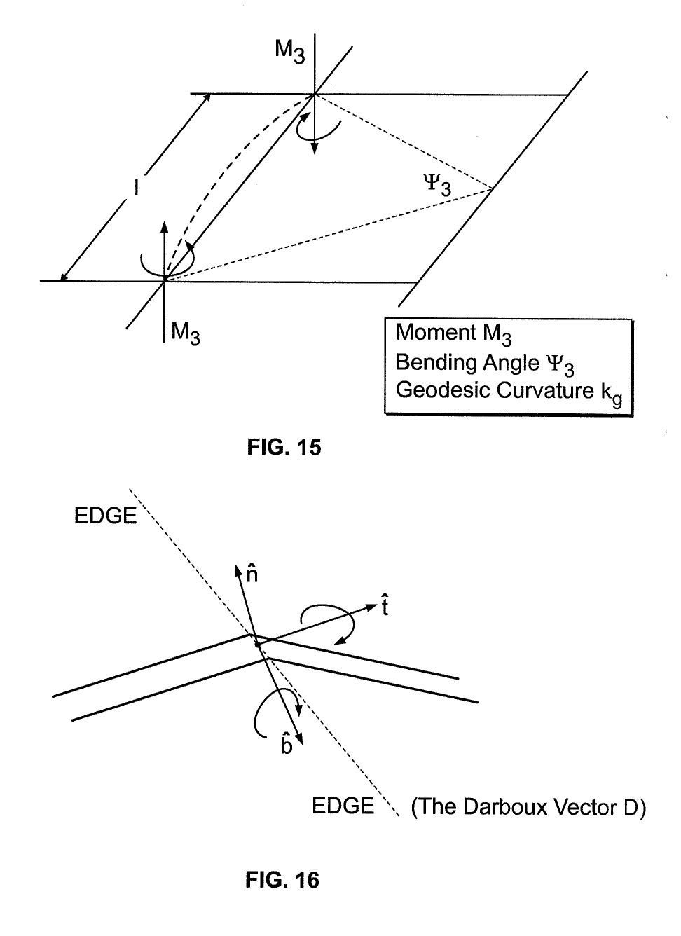

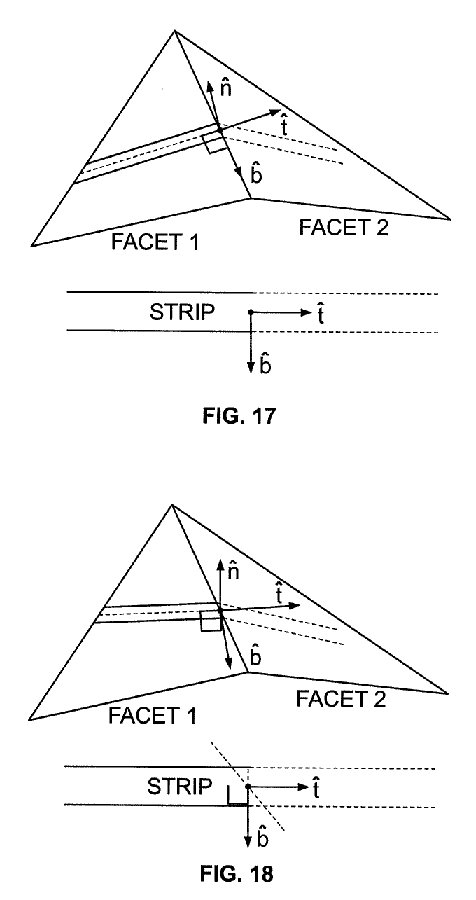

The Darboux vector is represented by Equation 8 which illustrates the lines of direction for the strip that is rotated over the edges of the tessellations. For Equation 5, the apportionment of torsion i and curvature kₙ. When a geodesic line approaches an edge perpendicular (as illustrated in FIG. 17), the Darboux frame vector fᵢ can dive/climb±ω²³. When the geodesic line approaches an edge with increasing obliqueness (decreasing from 90° as illustrated in vector graph 3), torsion begins to replace curvature and the line rolls/twists±ω²³. The twist±ω²³ and curvature±ω²³ at each crossing, stores mechanical strain energy in a material-strip 112.

$$\hat{D} = τ \hat{t} + {k}_{n} \hat{b} = {ω}^{23} \hat{t} + {ω}^{13} \hat{b} . \qquad Equation 5$$

In other examples, a geodesic line can be extended across a facet edge utilizing Equation 6. Equation 6 rotates the geodesic line on the facet about the common edge's normal. In Equation 6, vector nₑ approximates the surface normal vector of the smooth surface using two adjacent facets and can be weighted by the facet's areas. The normal vector nₑ on the edge bisects the normal vectors n_{f1} and n_{f2} of each adjoining facet. The process is repeated across the tessellated surface to form geodesic lines to form the geodesic net.

$${\hat{n}}_{e} = ( \frac{{n}_{f 1 x} - {n}_{f 2 x}}{2} ) {\hat{e}}_{1} + ( \frac{{n}_{f 1 y} - {n}_{f 2 y}}{2} ) {\hat{e}}_{2} + ( \frac{{n}_{f 1 z} - {n}_{f 2 z}}{2} ) {\hat{e}}_{3} \qquad Equation 6$$

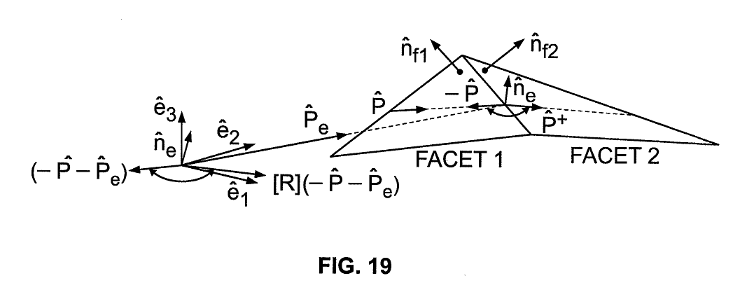

The vectors on a CAD tessellated surface are illustrated in FIG. 19. The vectors on the CAD tessellated surface illustrated in FIG. 19 are:
\hat{P} The vector on facet 1 in the direction of the geodesic.
−\hat{P} The vector on facet 1 in the opposite direction of the geodesic.
\hat{P}ₑ The vector from the origin (0,0,0) to the edge.
\hat{n}ₑ The vector normal on the common edge.
(−\hat{P}−\hat{P}ₑ) The vector translated for rotation about \hat{n}ₑ at origin (0,0,0).
\hat{P}* The vector on facet 2 in the direction of the extended geodesic.

In some examples, the doubly-curved mesh 110 is fabricated utilizing geometric data. The geodesic net provides geometric data for material-strips 112 that become geodesic lines in the doubly-curved mesh 110.

In other examples, a geodesic net is created on a surface for fabricating a doubly-curved mesh 110 with a predetermined bend and/or shape. In some aspects, the meshes 110 can be formed and/or bent into a predetermined shape by utilizing external elements, by affixing pre-tensioned elements, by affixing pre-twisted elements, and/or by utilizing by sizing the material-strip elements to apportion their stored strain energy. In some examples, the external elements are tension cables, struts, and/or other types of external fixtures that can be utilized to form and/or bend the mish thin surface.

An advantage of the fabrication techniques and meshes described herein is that the mesh is an efficient doubly-curved structure that has relatively little volume, yet effectively distribute loads over their entire form. Another advantage is that the rapid fabrication allows for the mesh to be utilized for a variety of uses that utilize multiple iterations of testing before construction. An additional advantage is that the mesh is functional and is utilized in the construction of light-weight vehicle bodies, material-conserving storage tanks, and large-span civil structures (e.g., bridges, stadiums).

Another advantage is that the mesh is a streamlined shape that reduces drag when utilized in vehicle bodies for ships, airplanes, and automobiles. An additional advantage is that a doubly-curved mesh is aesthetically pleasing to humans. Another advantage is that a doubly-curved mesh can be manufactured in-plane or in-surface mechanisms.

The above-described apparatuses and methods can be implemented in digital electronic circuitry, in computer hardware, firmware, software, robotic hardware, any type of electromechanical apparatus, and/or any type of hydraulic apparatus. The implementation can, for example, be a programmable processor, a computer, and/or multiple computers associated with an apparatus for fabricating the doubly-curved mesh.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application specific integrated circuit). Modules, subroutines, and software agents can refer to portions of the computer program, the processor, the special circuitry, software, and/or hardware that implements that functionality.

Comprise, include, and/or plural forms of each are open ended and include the listed parts and can include additional parts that are not listed. And/or is open ended and includes one or more of the listed parts and combinations of the listed parts.

While this invention has been particularly shown and described with references to specific embodiments thereof, it will be understood by those skilled in the art that various changes in form and details may be made therein without departing from the scope of the invention encompassed by the appended claims.

What is claimed is:

1. A method for fabricating a doubly-curved mesh, the method comprising:
providing a plurality of material-strips, each material-strip comprising a plurality of segments;
determining a length for at least one segment of at least one material-strip based on a distance between points on a geodesic line associated with the material-strip;
determining a width for at least one material-strip based on a computed twist, a computed bending angle, or both;
connecting the plurality of material-strips to form a plurality of quadrilaterals, each quadrilateral being defined by four edges; and
modifying at least one edge of at least one quadrilateral based on the determined length for the at least one segment to form the doubly-curved mesh.

2. The method of claim 1, wherein modifying distributes strain energy evenly throughout the doubly-curved mesh.

3. The method of claim 1, wherein the width for the material-strip is variable.

4. The method of claim 1, wherein the width for the material-strip is constant.

5. The method of claim 1, further comprising connecting a plurality of doubly-curved meshes.

6. The method of claim 5, wherein the connecting comprises overlapping, extending, interweaving, or any combination thereof of the plurality of doubly-curved meshes.

7. The method of claim 1, wherein each quadrilateral flexes independently from other quadrilaterals in the plurality of quadrilaterals.

8. The method of claim 1, further comprising covering the doubly-curved mesh with a material to form a doubly-curved shell.

9. The method of claim 8, wherein the material is concrete, plastic, resin, or any combination thereof.

10. The method of claim 1, wherein modifying changes interior angles of each quadrilateral in the plurality of quadrilaterals.

11. The method of claim 1, wherein the doubly-curved mesh is a form used for a structure.

12. The method of claim 1, wherein the material-strips comprise wood, paper, metal, plastic, resin, or any combination thereof.

13. The method of claim 1, further comprising creating one or more geodesic lines across triangular tessellation surfaces.

14. A concrete shell fabricated by the method of claim 1.

15. A vehicle body-panel fabricated by the method of claim 1.

16. A mold fabricated by the method of claim 1.

17. The mold of claim 16 having three dimensions, two dimensions, or one dimension.

18. A mesh shell fabricated by the method of claim 1 and comprising a reinforcing mat conformed to a shape of the doubly-curved mesh.

19. An antenna fabricated by the method of claim 1.

20. A medical implant fabricated by the method of claim 1.

21. A method for fabricating a doubly-curved mesh, the method comprising:
creating one or more geodesic lines across triangular tessellation surfaces;
creating a geodesic net based on the one or more geodesic lines;
connecting a plurality of material-strips to form a plurality of quadrilaterals, each quadrilateral being defined by four edges; and
modifying at least one edge of at least one quadrilateral based on the geodesic net.

22. The method of claim 21, further comprising determining a width for at least one material-strip based on a computed bending strain energy of the geodesic line associated with the material-strip.
